(19) United States
(12) Patent Application Publication
(10) Pub. No.: US 2015/0356877 A1
(43) Pub. Date: Dec. 10, 2015

(54) VISUAL ORGANIZATION ARCHITECTURE SYSTEM

(71) Applicant: Catherine Ann Downey, Atlanta, GA (US)

(72) Inventor: Catherine Ann Downey, Atlanta, GA (US)

(21) Appl. No.: 14/298,835

(22) Filed: Jun. 6, 2014

(51) Int. Cl. G09B 5/10; G09B 7/00; G09B 5/02

(52) U.S. Cl. CPC G09B 5/10; G09B 5/02; G09B 7/00

(57) ABSTRACT

A system and method for developing and deploying interactive learning software are each disclosed. In at least one embodiment, a system is provided for developing and deploying a non-linear presentation platform. In at least one embodiment, a method is provided for developing and deploying a non-linear presentation platform for interactive learning. In at least one embodiment, a computer readable storage medium encoded with programming for implementing the system and method is provided. The system, method, and computer readable storage medium encoded with programming each include a non-linear presentation platform that is visually presented as an interactive grid of tiles. Upon selection by a user of a particular interactive tile access to the content for that selected tile is provided.

### CROSS-REFERENCE TO RELATED APPLICATION(S)

The present non-provisional patent application claims the benefit of priority of U.S. Provisional Patent Application No. 61/832,145 which is entitled “VISUAL ORGANIZATION ARCHITECTURE SYSTEM”, which was filed on Jun. 6, 2013, and which is incorporated in full by reference herein.

### FIELD OF THE INVENTION

The technology described herein relates generally to software development systems and methods. In particular, the technology described herein pertains to a system and process for development of learning systems, namely a visual organization architecture system and associated processes and method steps.

### BACKGROUND OF THE INVENTION

Software development (also known as application development, software design, designing software, software application development, enterprise application development, or platform development) is the development of a software product. The term software development may be used to refer to the activity of computer programming, which is the process of writing and maintaining the source code, but in a broader sense of the term it includes all that is involved between the conception of the desired software through to the final manifestation of the software, ideally in a planned and structured process. Therefore, software development may include research, new development, prototyping, modification, reuse, re-engineering, maintenance, or any other activities that result in software products.

Software can be developed for a variety of purposes, the three most common being:
a. to meet specific needs of a specific client/business (the case with custom software);
b. to meet a perceived need of some set of potential users (the case with commercial and open source software); or
c. for personal use (e.g. a scientist may write software to automate a mundane task).

Embedded software development, i.e., the development of embedded software such as used for controlling consumer products, requires the development process to be integrated with the development of the controlled physical product.

The need for better quality control of the software development process has given rise to the discipline of software engineering, which aims to apply the systematic approach exemplified in the engineering paradigm to the process of software development.

There are several different approaches to software development, much like the various views of political parties toward governing a country. Some take a more structured, engineering-based approach to developing business solutions, whereas others may take a more incremental approach, where software evolves as it is developed piece-by-piece. Most methodologies share some combination of the following stages of software development:
a. Analyzing the problem;
b. Market research;
c. Gathering requirements for the proposed business solution;
d. Devising a plan or design for the software-based solution;
e. Implementation (coding) of the software;
f. Testing the software;
g. Deployment; and
h. Maintenance and bug fixing.

These stages are often referred to collectively as the software development lifecycle, or SDLC. Different approaches to software development may carry out these stages in different orders, or devote more or less time to different stages. The level of detail of the documentation produced at each stage of software development may also vary.

These stages may also be carried out in turn (a “waterfall” based approach), or they may be repeated over various cycles or iterations (a more “extreme” approach). The more extreme approach usually involves less time spent on planning and documentation, and more time spent on coding and development of automated tests.

More extreme approaches also promote continuous testing throughout the development lifecycle, as well as having a working (or bug-free) product at all times. More structured or “waterfall” based approaches attempt to assess the majority of risks and develop a detailed plan for the software before implementation (coding) begins, and avoid significant design changes and re-coding in later stages of the software development lifecycle planning.

There are significant advantages and disadvantages to the various methodologies, and the best approach to solving a problem using software will often depend on the type of problem. If the problem is well understood and a solution can be effectively planned out ahead of time, the more “waterfall” based approach may work the best. If, on the other hand, the problem is unique (at least to the development team) and the structure of the software solution cannot be easily envisioned, then a more “extreme” incremental approach may work best.

A software development process is a structure imposed on the development of a software product. Synonyms include software life cycle and software process. There are several models for such processes, each describing approaches to a variety of tasks or activities that take place during the process.

E-learning refers to the use of electronic media and information and communication technologies in education. E-learning is broadly inclusive of all forms of educational technology in learning and teaching. E-learning is inclusive of, and is broadly synonymous with multimedia learning, technology-enhanced learning, computer-based instruction, computer-based training, computer-assisted instruction or computer-aided instruction, internet-based training, web-based training, online education, virtual education, virtual learning environments (which are also called learning platforms), m-learning, and digital educational collaboration. These alternative names emphasize a particular aspect, component or delivery method.

E-learning includes numerous types of media that deliver text, audio, images, animation, and streaming video, and includes technology applications and processes such as audio or video tape, satellite TV, CD-ROM, and computer-based learning, as well as local intranet/extranet and web-based learning. Information and communication systems, whether free-standing or based on either local networks or the Internet in networked learning, underlie many e-learning processes.

E-learning can occur in or out of the classroom. It can be self-paced, asynchronous learning or may be instructor-led, synchronous learning. E-learning is suited to distance learning and flexible learning, but it can also be used in conjunction with face-to-face teaching, in which case the term blended learning is commonly used.

E-learning refers to the use of technology in learning and education. There are several aspects to describing the intellectual and technical development of E-learning, which can be categorized into discrete areas:
a. E-learning as an educational approach or tool that supports traditional subjects;
b. E-learning as a technological medium that assists in the communication of knowledge, and its development and exchange;
c. E-learning itself as an educational subject; such courses may be called Computer Studies or Information and Communication Technology; and
d. E-learning administrative tools such as education management information systems.

E-learning is a broadly inclusive term that describes educational technology that electronically or technologically supports learning and teaching. Some advocate that the “E” should be interpreted to mean “exciting, energetic, enthusiastic, emotional, extended, excellent, and educational” in addition to “electronic.” This broad interpretation focuses on new applications and developments, and also brings learning and media psychology into consideration. Other suggest that the “E” should refer to “everything, everyone, engaging, easy”.

Depending on whether a particular aspect, component or delivery method is given emphasis, a wide array of similar or overlapping terms has been used. As such, e-learning encompasses multimedia learning, technology-enhanced learning, computer-based training, computer-assisted instruction, internet-based training, web-based training, online education, virtual education, virtual learning environments which are also called learning platforms, m-learning, digital educational collaboration, distributed learning, computer-mediated communication, cyber-learning, and multi-modal instruction. Every one of these numerous terms has had its advocates, who point up particular potential distinctions.

A recurring problem in learning systems pertains to the linear presentation of massive quantities of dull material that overwhelms the learner and creates discouragement and reduces retention and completion. These and other problems exist.

Related patents and published patent applications known in the background art include the following:

U.S. Pat. No. 5,303,388, issued to Kreitman et al. on Apr. 12, 1994, discloses a manipulable icon is displayed with multiple faces having particular application to computer displays and systems. The icon, which represents information about an object available within the computer, can be manipulated by the user to display different faces or views which provide additional information about the object represented by the icon. The user has the ability to manipulate the icon to see additional views of the icon on the computer display device, either by a mouse stroke selection command, keyboard command or menu selection. This selection causes the icon to move from one view or face of the icon to another view or face of the icon. These additional views thus provide additional space in which the icon can supply additional information to the user. Iconic movement from one face or view to another is also typically accompanied by some sound which indicates execution of the movement.

U.S. Published Patent Application No. 2008/0090220, inventor Freeman et al., published on Apr. 17, 2008, discloses a multimedia reproduction system which comprises a computing subsystem operably connected to and controlling one or more of video, audio, and olfactory subsystems. The system accepts user input and adapts a multimedia presentation in response thereto. The subsystems are easily separable and configured in carrying cases that protect them during transport. The subsystems easily connect (physically and electronically) to each other upon delivery to form a system that presents 3-D, high definition video, surround-sound audio, and even scents from local and/or remote sources.

U.S. Pat. No. 8,286,099, issued to Dubs et al. on Oct. 9, 2012, discloses a display module which displays a first face of a virtual multidimensional solid comprising a plurality of faces. Each face comprises graphical user interface controls for a unique function set. An input module receives a rotational command that rotates the multidimensional solid around at least one axis. A rotation module rotates the multidimensional solid to display a second face in response to the rotational command, displaying the rotation of the multidimensional solid.

The foregoing published patent application and non-patent information reflect the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

The technology described herein pertains to a process for developing interactive learning software.

The technology described herein pertains to a software product that allows for a large set of information to be visually organized into chunk-able & easily digestible learning modules as well as a non-linear presentation platform represented visually as an interactive grid of tiles.

This software product is referenced as Visual Organization Architecture (VORGAR).

VORGAR is comprised of:
a. Interactive components;
b. Video;
c. Graphics;
d. Text;
e. Quizzes;
f. Feedback;
g. Learning checkpoints/Saved Progress; and
h. User login

VORGAR and its content is developed by using the following software, but not limited to:
a. Adobe Flash;
b. Adobe Dreamweaver;
c. Adobe After Effects;
d. Adobe Media Encoder;
e. Adobe Photoshop; and
f. Adobe Illustrator.

VORGAR is delivered as a web application with all the features available in at least one embodiment. VORGAR is delivered as a physical disc with limited features in at least one embodiment.

Device Compatibility: By way of example, and not of limitation, VORGAR is deployable on either a PC as an executable file (.exe), or onto a Mac as an application file (.app). VORGAR is compatible with all browsers that have Flash Player 9.0 or later installed.

Developing Language: By way of example, and not of limitation, the programming language used to develop VORGAR is Adobe Flash's ActionScript 3.0 (AS3).

The process of creating and deploying a VORGAR application is comprised of (but not limited to) the following steps, and in which some method steps may be omitted, and in which the order may be varied in various embodiments and implementations:
a. Gather all information that will be integrated into VORGAR;
b. Decide on the number of tiles that appears in VORGAR, which is determined on how the information is broken down into individual learning units, and how many learning units are needed. One learning unit is used behind one tile;
c. Decide on the dimensions of the tile grid (e.g. 6 tiles wide by 4 tiles high), depending on the number of learning units decided upon, will determine the dimensions of the learning grid;
d. Creating the artwork for various elements that make up the graphic look;
e. Tile images (front/back);
f. GUI (Graphical User Interface);
g. Create content to be used inside of each learning unit;
h. Add desired graphics;
i. Video;
j. Shoot high quality video;
k. Edit video;
l. Compress video;
m. Save compressed video;
n. Create multi-choice questions for each learning module that requires them;
o. Export VORGAR for web;
p. Setup user portal on the web;
q. Create a database for users and their progress;
r. Allows users to login/log out;
s. Saves user score/progress as they complete;
t. Upload VORGAR to the server; and
u. Connect VORGAR to the database.

In one exemplary embodiment, the technology described herein provides a method for developing and deploying a non-linear presentation platform for interactive learning. The method includes: gathering a plurality of information data points that will be integrated into the non-linear presentation platform; determining a plurality of tiles for an interactive visual presentation tile grid; determining a plurality of dimensions for the interactive visual presentation tile grid; creating at least one artwork piece for each tile in the interactive visual presentation tile grid; creating a front image and a back image for each tile in the interactive visual presentation tile grid; and forming a Graphical User Interface (GUI) for each tile; thereby creating a plurality of user-selectable learning module access points through the interactive visual presentation tile grid.

In at least one embodiment, the method also includes: creating a plurality of bodies of content, each body of content created for association with one of the tiles in the interactive tile grid through the plurality of user-selectable learning module access points through the interactive visual presentation tile grid; thereby creating a plurality of user-selectable learning modules through the access points of the interactive visual presentation tile grid.

In at least one embodiment, the method also includes: creating a plurality of graphics, each graphic defined for each body of content for association with each tile in the interactive tile grid; and coupling each graphic to its respective body of content.

In at least one embodiment, the method also includes: determining a plurality of video content packages, each determined for use with one of a plurality of videos, each video paired within each body of content created for association with one of the tiles in the interactive tile grid through the plurality of user-selectable learning module access points through the interactive visual presentation tile grid; shooting a plurality of high quality videos based on the plurality of video content packages; editing each video to create an edited video; compressing each edited video to form a compressed video; and saving each compressed video to form a saved compressed video; thereby pairing at least one video to each body of content for association with each tile in the interactive tile grid.

In at least one embodiment, the method also includes creating a plurality of multi-choice questions for each learning module through the interactive visual presentation tile grid.

In at least one embodiment, the method also includes: creating a Visual Organization Architecture (VORGAR) from the interactive visual presentation tile grid and each body of content for association with each tile in the interactive tile grid for export to a web; and exporting the VORGAR to the web for accessibility by users over a web-based interface.

In at least one embodiment, the method also includes: setting up a user portal for accessibility by a plurality of users access the portal on the world wide web public network; creating a Visual Organization Architecture (VORGAR) database for recording user access and tracking users and user progress; recording user access to the user portal and to the VORGAR database; tracking user progress in the learning modules; and allowing users to log in and log out.

In at least one embodiment, the method also includes: utilizing a server having accessibility to the world wide web public network; uploading the VORGAR to the server; and connecting the VORGAR to the VORGAR database.

In at least one embodiment, the method also includes saving a plurality of scores and a plurality of progress charts from users as users complete each learning module.

In another exemplary embodiment, the technology described herein provides a computer readable storage medium encoded with programming for implementing a system for developing and deploying a non-linear presentation platform. The computer readable storage medium is encoded with programming configured to: gather a plurality of information data points that will be integrated into the non-linear presentation platform; determine a plurality of tiles for an interactive visual presentation tile grid; determine a plurality of dimensions for the interactive visual presentation tile grid; create at least one artwork piece for each tile in the interactive visual presentation tile grid; create a front image and a back image for each tile in the interactive visual presentation tile grid; and form a Graphical User Interface (GUI) for each tile; thereby to create a plurality of user-selectable learning module access points through the interactive visual presentation tile grid.

In at least one embodiment, the programming in the computer readable storage medium is also configured to: create a plurality of bodies of content, each body of content created for association with one of the tiles in the interactive tile grid through the plurality of user-selectable learning module access points through the interactive visual presentation tile grid; thereby to create a plurality of user-selectable learning modules through the access points of the interactive visual presentation tile grid.

In at least one embodiment, the programming in the computer readable storage medium is also configured to: create a plurality of graphics, each graphic defined for each body of content for association with each tile in the interactive tile grid; and couple each graphic to its respective body of content.

In at least one embodiment, the programming in the computer readable storage medium is also configured to: determine a plurality of video content packages, each determined for use with one of a plurality of videos, each video paired within each body of content created for association with one of the tiles in the interactive tile grid through the plurality of user-selectable learning module access points through the interactive visual presentation tile grid; shoot a plurality of high quality videos based on the plurality of video content packages; edit each video to create an edited video; compress each edited video to form a compressed video; and save each compressed video to form a saved compressed video; thereby pair at least one video to each body of content for association with each tile in the interactive tile grid.

In at least one embodiment, the programming in the computer readable storage medium is also configured to: create a plurality of multi-choice questions for each learning module through the interactive visual presentation tile grid.

In at least one embodiment, the programming in the computer readable storage medium is also configured to: create a Visual Organization Architecture (VORGAR) from the interactive visual presentation tile grid and each body of content for association with each tile in the interactive tile grid for export to a web; export the VORGAR to the web for accessibility by users over a web-based interface; set up a user portal for accessibility by a plurality of users access the portal on the world wide web public network; create a Visual Organization Architecture (VORGAR) database for recording user access and tracking users and user progress; record user access to the user portal and to the VORGAR database; track user progress in the learning modules; allow users to log in and log out; utilize a server having accessibility to the world wide web public network; upload the VORGAR to the server; connect the VORGAR to the VORGAR database; and save a plurality of scores and a plurality of progress charts from users as users complete each learning module.

In yet another exemplary embodiment, the technology described herein provides a system for developing and deploying a non-linear presentation platform. The system includes: at least one server accessible over the world wide web public network and configured to allow user and developer access and to host a database; a secure database consisting of a plurality of database modules for the storage of data pertaining to the non-linear presentation platform; an interactive grid of tiles formed within the non-linear presentation platform; a user interface through which developers access the non-linear presentation platform across the network to design and develop a training course responsively as a client makes decisions on requirements and content; and a user interface through which users access the non-linear presentation platform across the network. The system is configured to: gather a plurality of information data points that will be integrated into the non-linear presentation platform; determine a plurality of tiles for an interactive visual presentation tile grid; determine a plurality of dimensions for the interactive visual presentation tile grid; create at least one artwork piece for each tile in the interactive visual presentation tile grid; create a front image and a back image for each tile in the interactive visual presentation tile grid; and form a Graphical User Interface (GUI) for each tile; thereby to create a plurality of user-selectable learning module access points through the interactive visual presentation tile grid.

In at least one embodiment of the system, the system is further configured to: create a plurality of bodies of content, each body of content created for association with one of the tiles in the interactive tile grid through the plurality of user-selectable learning module access points through the interactive visual presentation tile grid; thereby to create a plurality of user-selectable learning modules through the access points of the interactive visual presentation tile grid.

In at least one embodiment of the system, the system is further configured to: create a plurality of multi-choice questions for each learning module through the interactive visual presentation tile grid; create a plurality of graphics, each graphic defined for each body of content for association with each tile in the interactive tile grid; and couple each graphic to its respective body of content.

In at least one embodiment of the system, the system is further configured to: determine a plurality of video content packages, each determined for use with one of a plurality of videos, each video paired within each body of content created for association with one of the tiles in the interactive tile grid through the plurality of user-selectable learning module access points through the interactive visual presentation tile grid; shoot a plurality of high quality videos based on the plurality of video content packages; edit each video to create an edited video; compress each edited video to form a compressed video; and save each compressed video to form a saved compressed video; thereby pair at least one video to each body of content for association with each tile in the interactive tile grid.

In at least one embodiment of the system, the system is further configured to: create a Visual Organization Architecture (VORGAR) from the interactive visual presentation tile grid and each body of content for association with each tile in the interactive tile grid for export to a web; export the VORGAR to the web for accessibility by users over a web-based interface; set up a user portal for accessibility by a plurality of users access the portal on the world wide web public network; create a Visual Organization Architecture (VORGAR) database for recording user access and tracking users and user progress; record user access to the user portal and to the VORGAR database; track user progress in the learning modules; allow users to log in and log out; utilize a server having accessibility to the world wide web public network; upload the VORGAR to the server; connect the VORGAR to the VORGAR database; and save a plurality of scores and a plurality of progress charts from users as users complete each learning module.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the technology is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein will be better understood by reading the detailed description of the invention with reference to the accompanying drawing figures, in which like reference numerals denote similar structure and refer to like elements throughout, and in which:

FIG. 1 is a flowchart diagram illustrating a typical development and deployment process for a VORGAR application, according to an embodiment of the technology described herein;

FIG. 2 is a flowchart diagram illustrating a typical development and deployment process for a VORGAR application, as continued from the flowchart steps depicted in FIG. 1, according to an embodiment of the technology described herein;

FIG. 3 is a schematic diagram depicting a typical VORGAR tile display, illustrating, in particular an array of interactive tiles that can rotate and provide access to the learning content associated with each tile, according to an embodiment of the technology described herein;

FIG. 4 is a schematic diagram depicting a typical VORGAR tile display, illustrating, in particular, a highlighted tile after selection, according to an embodiment of the technology described herein;

FIG. 5 is a schematic diagram illustrating a system architecture for a process for development of learning systems, namely a visual organization architecture system and associated processes and method steps; and

FIG. 6 is a block diagram illustrating the general components of a computer according to an exemplary embodiment of the technology, and upon which any one or more of the method steps described within are implemented in various embodiments.

### DETAILED DESCRIPTION OF THE INVENTION

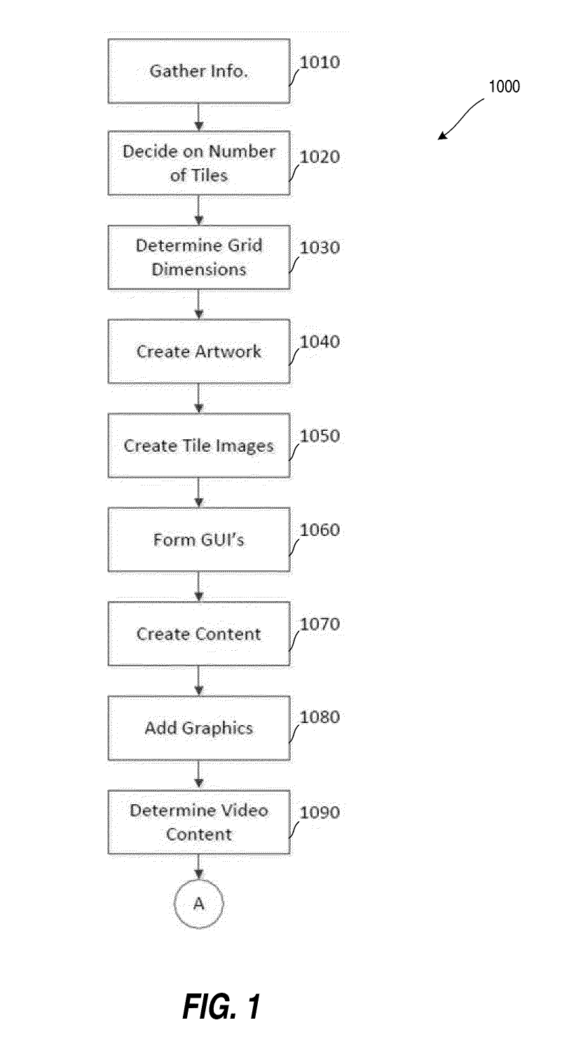

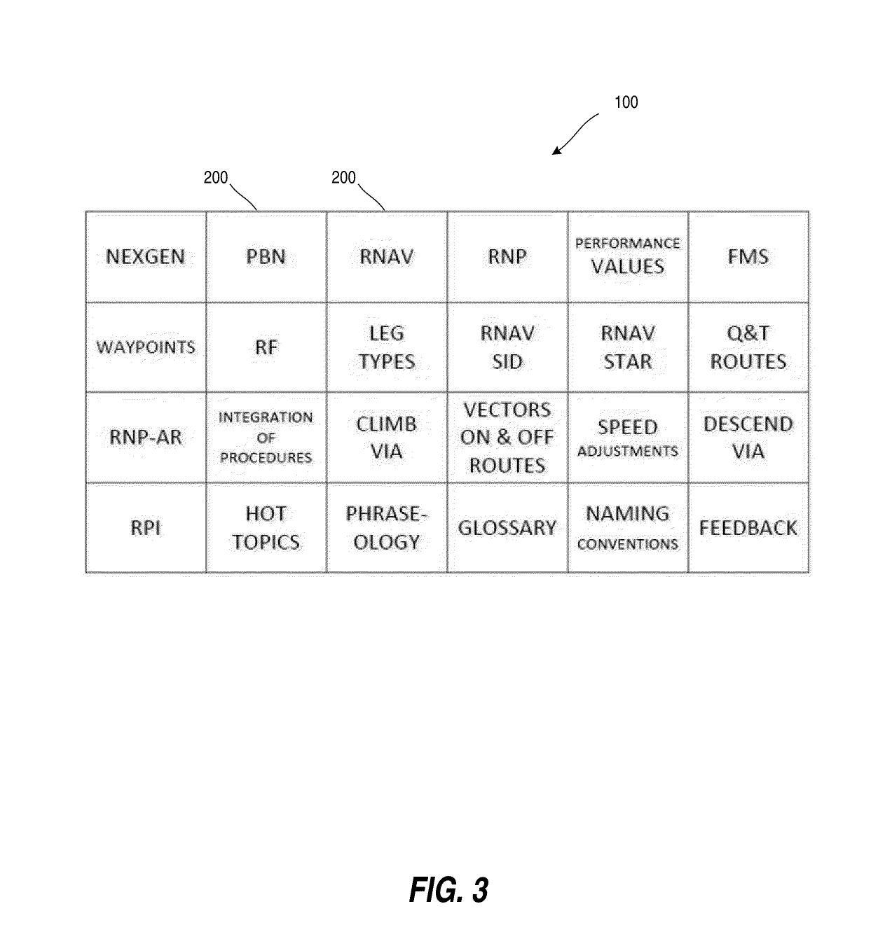

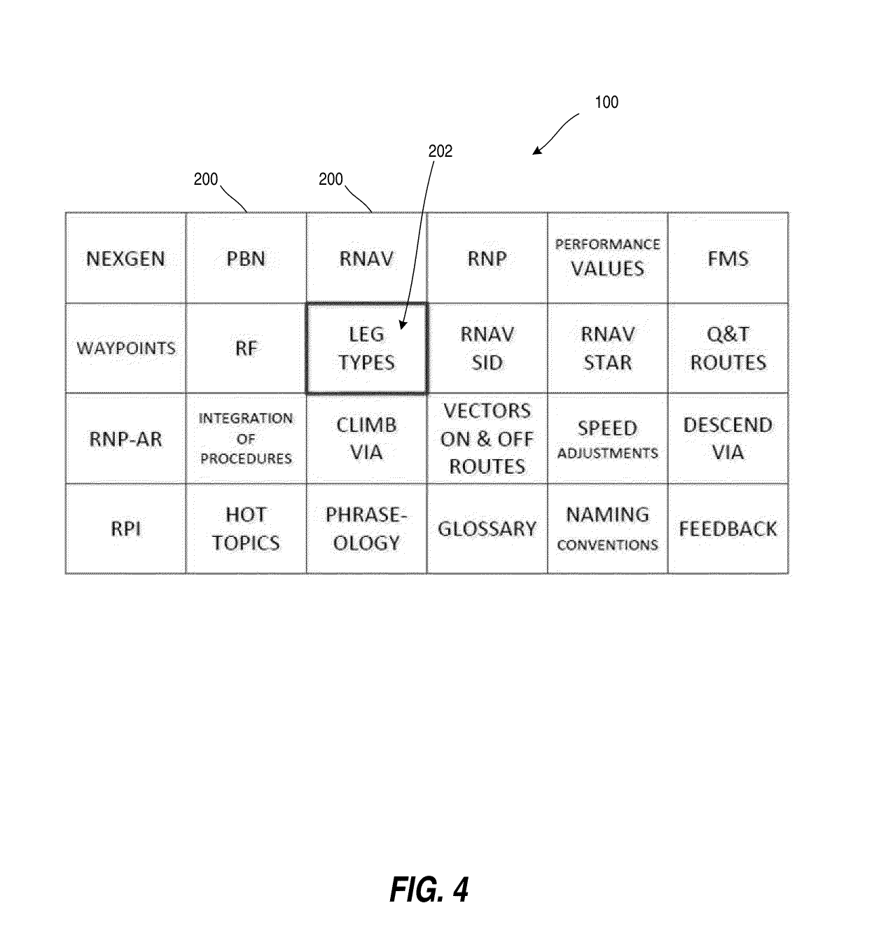

In describing the preferred and other embodiments of the technology described herein, as illustrated in FIGS. 1 through 6, specific terminology is employed for the sake of clarity. The invention, however, is not intended to be limited to the specific terminology so selected, and it is to be understood that each specific element includes all technical equivalents that operate in a similar manner to accomplish similar functions. For example, this process is not limited to training course development.

Referring now to FIGS. 1 through 6, illustrated therein is a creation and deployment method process, system, and computer readable storage medium for a software product, entitled Visual Organization Architecture (VORGAR) that allows for a large set of information to be visually organized into chunk-able & easily digestible learning modules. VORGAR is a non-linear presentation platform and is visually presented as an interactive grid 100 of tiles 200 that provide access to the content for the selected tile 202.

VORGAR is comprised of, in various combinations and embodiments, the following elements:
a. Interactive components;
b. Video;
c. Graphics;
d. Text;
e. Quizzes;
f. Feedback;
g. Learning checkpoints;
h. Saved Progress; and
i. User login.

VORGAR and its content is developed, by way of example, and not of limitation, by using the following software:
a. Adobe Flash;
b. Adobe Dreamweaver;
c. Adobe after Effects;
d. Adobe Media Encoder;
e. Adobe Photoshop; and
f. Adobe Illustrator.

VORGAR is delivered as a web application with all the features available, in at least one embodiment. VORGAR is delivered as a physical disc with limited features, in at least one embodiment.

Device Compatibility: By way of example, and not of limitation, VORGAR is deployable on either a PC as an executable file (.exe), or onto a Mac as an application file (.app). VORGAR is compatible with all browsers that have Flash Player 9.0 or later installed.

Developing Language: By way of example, and not of limitation, the programming language used to develop VORGAR is Adobe Flash's ActionScript 3.0 (AS3).

The process of creating and deploying a VORGAR application is comprised of (but not limited to) the following steps, in chart 1000:
a. 1010 gathering all information that will be integrated into VORGAR;
b. 1020 deciding on the number of tiles that appears in VORGAR (this is determined on how the information is broken down, i.e., “chunked” into individual learning units, and how many learning units are needed. In a preferred embodiment, one learning unit is behind one tile.);
c. 1030 deciding on the dimensions of the tile grid (e.g. 6 tiles wide by 4 tiles high); in general, the number of learning units decided upon determines the dimensions of the learning grid;
d. 1040 creating the artwork for various elements that make up the graphic “look”;
e. 1050 creating the front and back images for each tile images;
f. 1060 forming the GUI (Graphical User Interface) associated with each tile image;
g. 1070 creating content to be used inside of each learning unit;
h. 1080 adding the desired graphics;
i. 1090 deciding on the content for each video;
j. 1100 shooting high quality video;
k. 1110 editing each video;
l. 1110 compressing each video;
m. 1110 saving each compressed video;
n. creating multi-choice questions for each learning module, if required:
o. 1120 exporting VORGAR for web;
p. 1130 setting up a user portal on the web;
q. 1140 creating a database for users and their progress;
r. 1150 allowing users to login/log out;
s. 1160 uploading VORGAR to the server;
t. 1170 connecting VORGAR to the database, and
u. 1180 saving user score/progress as they complete.

In step 1010, information deemed useful to the learning module is gathered. The gathered information is integrated into VORGAR.

In step 1020, it is determined the number of tiles to include in the interactive visual tile grid, to appear in VORGAR. This is determined on how the information is broken down, i.e., “chunked” into individual learning units, and how many learning units are needed. In a preferred embodiment, one learning unit is behind one tile.

In step 1030, it is determined the dimensions of the tile grid. By way of example, and not of limitation, the grid is sic tiles wide and four tiles high. In general, the number of learning units decided upon determines the dimensions of the learning grid.

In step 1040, artwork and graphics are created. The artwork and graphics provide a look and feel to the tile grid.

In step 1050, a front image of each tile is created. Additionally, in this step, a back image of each tile is created.

In step 1060, a graphical user interface (GUI) is formed. The GUI is associated with each tile image.

In step 1070, content is created to be used inside of each interactive learning unit.

In step 1080, graphics are added to the interactive tile grid as desired to improve the interactive learning experience.

In step 1090, video content is determined. Video content is used to pair with each learning module to facilitate ease of use and learning.

In step 1100, high quality video is taken for use with each learning module to facilitate ease of use and learning.

In step 1110, as needed, the videos are edited.

In step 1110, as needed, the videos are compressed.

In step 1110, as needed, the compressed videos saved.

Multi-choice questions for each learning module are created as desired or required by the given learning experience.

In step 1120, the VORGAR is exported to the world wide web.

In step 1130, a user portal is created to be accessible on the world wide web.

In step 1140, a database for users and their progress is created.

In step 1150, the system and portal is configured such that users my log in and log out as desired.

In step 1160, the VORGAR is uploaded to the server.

In step 1170, VORGAR is connected to the database.

In step 1180, user scores and user progress are recorded and tracker as each user completes each user learning module.

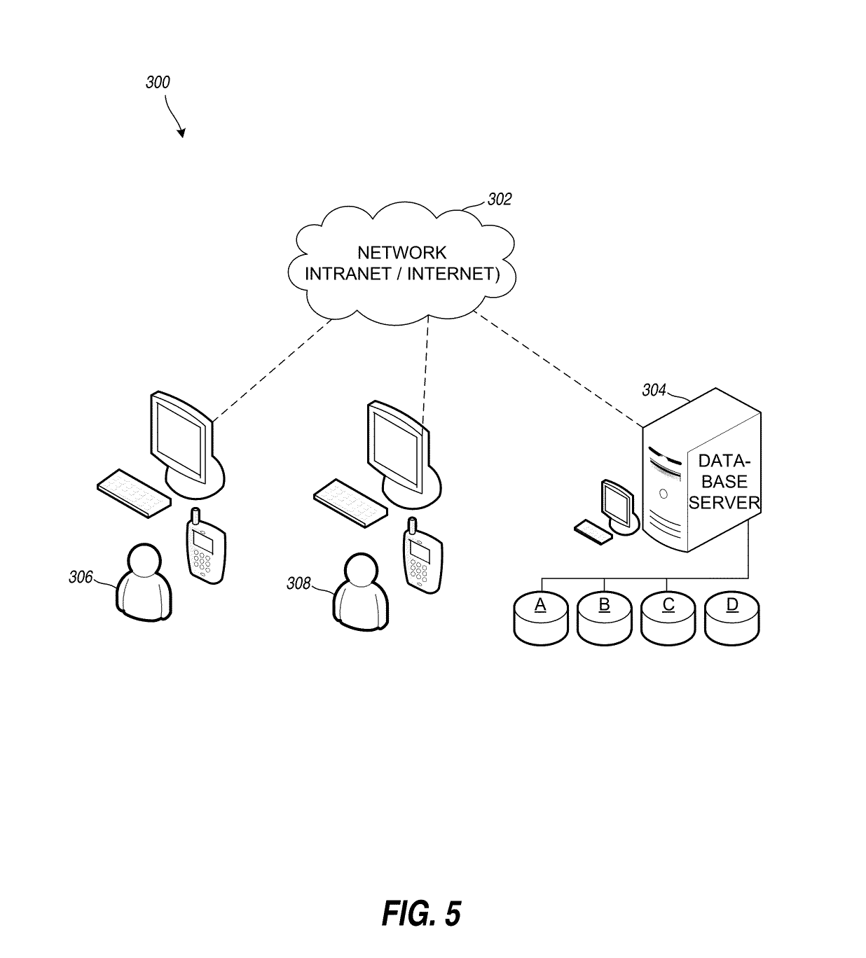

Referring now to the FIG. 5, illustrated therein is a schematic diagram 300 illustrating a system architecture for developing and deploying a non-linear presentation platform for interactive learning.

In at least one embodiment, client 306 and developer 208 are in communications with a network server over a network 302. Network 302 includes internet and or intranet networks in various embodiments. Such communications includes access to database server 304, or like servers, for the development and deployment of non-linear presentation platform for interactive learning for the client 306. Additionally, such communications can include use of devices such as computers, smart phones, routers, and like communications devices.

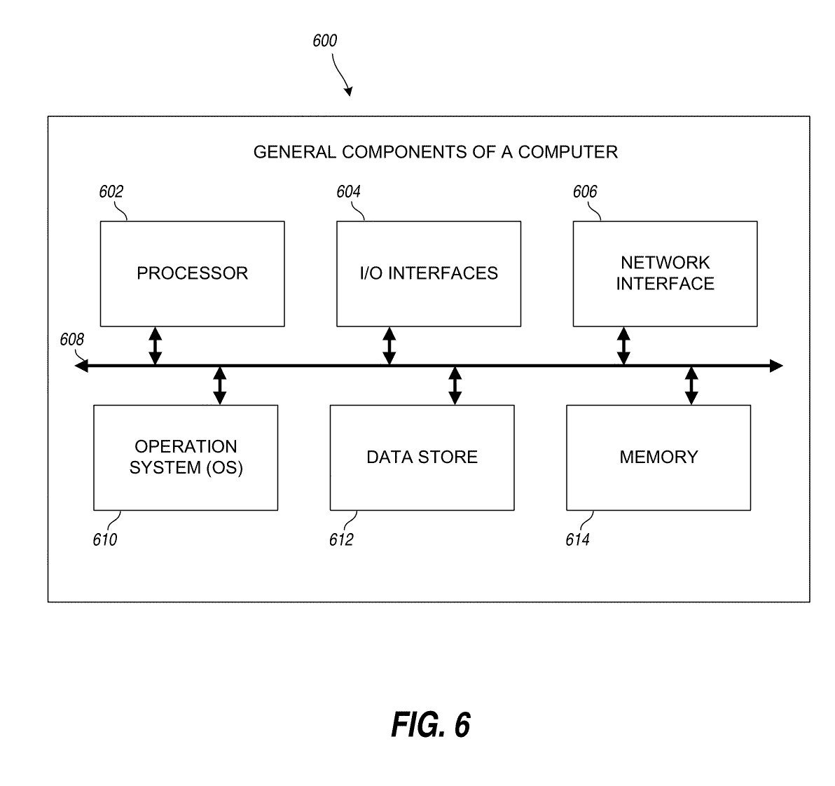

Referring now to FIG. 6, a block diagram 600 illustrating the general components of a computer is shown. Any one or more of the computers, laptops, servers, databases, and the like, disclosed above, may be implemented with such hardware and software components. The computer 600 can be a digital/virtual computer that, in terms of hardware architecture, generally includes a processor 602, input/output (I/O) interfaces 604, network interfaces 606, an operating system (O/S) 610, a data store 612, and a memory 614. The components (602, 604, 606, 610, 612, and 614) are communicatively coupled via a local interface 608. The local interface 608 can be, for example but not limited to, one or more buses or other wired or wireless connections, as is known in the art. The local interface 608 can have additional elements, which are omitted for simplicity, such as controllers, buffers (caches), drivers, among many others, to enable communications. Further, the local interface 608 can include address, control, and/or data connections to enable appropriate communications among the aforementioned components. The general operation of a computer comprising these elements is well known in the art. In at least one embodiment, one or more aspects of the method are hosted in the network cloud, in one or more of a cloud computing model, nanotechnology model, or biotechnology model.

The processor 602 is a hardware device for executing software instructions. The processor 602 can be any custom made or commercially available processor, a central processing unit (CPU), an auxiliary processor among several processors associated with the computer 600, a semiconductor-based microprocessor (in the form of a microchip or chip set), or generally any device for executing software instructions. When the computer 600 is in operation, the processor 602 is configured to execute software stored within the memory 614, to communicate data to and from the memory 614, and to generally control operations of the computer 600 pursuant to the software instructions.

The I/O interfaces 604 can be used to receive user input from and/or for providing system output to one or more devices or components. User input can be provided via, for example, a keyboard and/or a mouse. System output can be provided via a display device and a printer. I/O interfaces 604 can include, for example but not limited to, a serial port, a parallel port, a small computer system interface (SCSI), an infrared (IR) interface, a radio frequency (RF) interface, and/or a universal serial bus (USB) interface.

The network interfaces 606 can be used to enable the computer 300 to communicate on a network. For example, the computer 600 can utilize the network interfaces 608 to communicate via the internet to other computers or servers for software updates, technical support, etc. The network interfaces 608 can include, for example, an Ethernet card (e.g., 10BaseT, Fast Ethernet, Gigabit Ethernet) or a wireless local area network (WLAN) card (e.g., 802.11a/b/g). The network interfaces 608 can include address, control, and/or data connections to enable appropriate communications on the network.

A data store 612 can be used to store data, such as information regarding positions entered in a requisition. The data store 612 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 612 can incorporate electronic, magnetic, optical, and/or other types of storage media. In one example, the data store 612 can be located internal to the computer 600 such as, for example, an internal hard drive connected to the local interface 608 in the computer 600. Additionally in another embodiment, the data store can be located external to the computer 600 such as, for example, an external hard drive connected to the I/O interfaces 604 (e.g., SCSI or USB connection). Finally in a third embodiment, the data store may be connected to the computer 300 through a network, such as, for example, a network attached file server.

The memory 614 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 614 may incorporate electronic, magnetic, optical, and/or other types of storage media. Note that the memory 614 can have a distributed architecture, where various components are situated remotely from one another, but can be accessed by the processor 602.

The software in memory 614 can include one or more software programs, each of which includes an ordered listing of executable instructions for implementing logical functions. The operating system 610 essentially controls the execution of other computer programs, such as the interactive toolkit for sourcing valuation, and provides scheduling, input-output control, file and data management, memory management, and communication control and related services. The operating system 610 can be any of Windows Server, Windows Azure, Windows NT, Windows 2000, Windows XP, Windows Vista, Windows 7, Windows 8 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), SendGrid, Amazon, Android, or other like operating system with similar functionality.

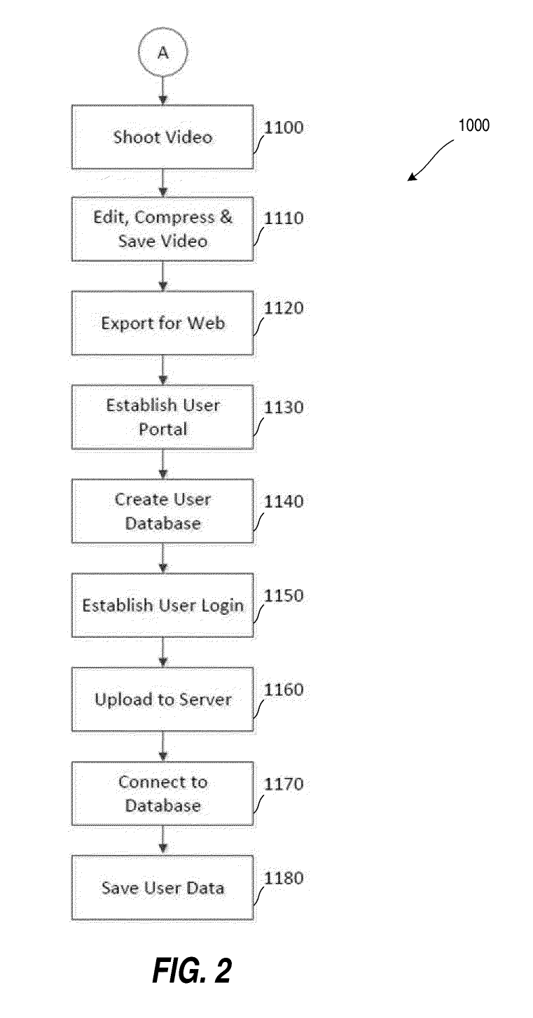

In an exemplary embodiment of the technology described herein, one or more computers 600 are configured to perform one or more elements of flowchart 1000, as depicted in FIG. 1 and FIG. 2.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology.

What is claimed is:

1. A method for developing and deploying a non-linear presentation platform for interactive learning, the method comprising:
gathering a plurality of information data points that will be integrated into the non-linear presentation platform;
determining a plurality of tiles for an interactive visual presentation tile grid;
determining a plurality of dimensions for the interactive visual presentation tile grid;
creating at least one artwork piece for each tile in the interactive visual presentation tile grid;
creating a front image and a back image for each tile in the interactive visual presentation tile grid; and
forming a Graphical User Interface (GUI) for each tile;
thereby creating a plurality of user-selectable learning module access points through the interactive visual presentation tile grid.

2. The method of claim 1, further comprising:
creating a plurality of bodies of content, each body of content created for association with one of the tiles in the interactive tile grid through the plurality of user-selectable learning module access points through the interactive visual presentation tile grid;
thereby creating a plurality of user-selectable learning modules through the access points of the interactive visual presentation tile grid.

3. The method of claim 2, further comprising:
creating a plurality of graphics, each graphic defined for each body of content for association with each tile in the interactive tile grid; and
coupling each graphic to its respective body of content.

4. The method of claim 2, further comprising:
determining a plurality of video content packages, each determined for use with one of a plurality of videos, each video paired within each body of content created for association with one of the tiles in the interactive tile grid through the plurality of user-selectable learning module access points through the interactive visual presentation tile grid;
shooting a plurality of high quality videos based on the plurality of video content packages;
editing each video to create an edited video;
compressing each edited video to form a compressed video; and
saving each compressed video to form a saved compressed video;
thereby pairing at least one video to each body of content for association with each tile in the interactive tile grid.

5. The method of claim 2, further comprising:
creating a plurality of multi-choice questions for each learning module through the interactive visual presentation tile grid.

6. The method of claim 2, further comprising:
creating a Visual Organization Architecture (VORGAR) from the interactive visual presentation tile grid and each body of content for association with each tile in the interactive tile grid for export to a web; and
exporting the VORGAR to the web for accessibility by users over a web-based interface.

7. The method of claim 6, further comprising:
setting up a user portal for accessibility by a plurality of users access the portal on the world wide web public network;
creating a Visual Organization Architecture (VORGAR) database for recording user access and tracking users and user progress;
recording user access to the user portal and to the VORGAR database;
tracking user progress in the learning modules; and
allowing users to log in and log out.

8. The method of claim 7, further comprising:
utilizing a server having accessibility to the world wide web public network;
uploading the VORGAR to the server; and
connecting the VORGAR to the VORGAR database.

9. The method of claim 7, further comprising:
saving a plurality of scores and a plurality of progress charts from users as users complete each learning module.

10. A computer readable storage medium encoded with programming for implementing a system for developing and deploying a non-linear presentation platform, the computer readable storage medium encoded with programming configured to:
gather a plurality of information data points that will be integrated into the non-linear presentation platform;
determine a plurality of tiles for an interactive visual presentation tile grid;
determine a plurality of dimensions for the interactive visual presentation tile grid;
create at least one artwork piece for each tile in the interactive visual presentation tile grid;
create a front image and a back image for each tile in the interactive visual presentation tile grid; and
form a Graphical User Interface (GUI) for each tile;
thereby to create a plurality of user-selectable learning module access points through the interactive visual presentation tile grid.

11. The computer readable storage medium of claim 10, wherein the programming is further configured to:
create a plurality of bodies of content, each body of content created for association with one of the tiles in the interactive tile grid through the plurality of user-selectable learning module access points through the interactive visual presentation tile grid;
thereby to create a plurality of user-selectable learning modules through the access points of the interactive visual presentation tile grid.

12. The computer readable storage medium of claim 11, wherein the programming is further configured to:
create a plurality of graphics, each graphic defined for each body of content for association with each tile in the interactive tile grid; and
couple each graphic to its respective body of content.

13. The computer readable storage medium of claim 11, wherein the programming is further configured to:
determine a plurality of video content packages, each determined for use with one of a plurality of videos, each video paired within each body of content created for association with one of the tiles in the interactive tile grid through the plurality of user-selectable learning module access points through the interactive visual presentation tile grid;
shoot a plurality of high quality videos based on the plurality of video content packages;
edit each video to create an edited video;
compress each edited video to form a compressed video; and
save each compressed video to form a saved compressed video;
thereby pair at least one video to each body of content for association with each tile in the interactive tile grid.

14. The computer readable storage medium of claim 11, wherein the programming is further configured to:
create a plurality of multi-choice questions for each learning module through the interactive visual presentation tile grid.

15. The computer readable storage medium of claim 11, wherein the programming is further configured to:
create a Visual Organization Architecture (VORGAR) from the interactive visual presentation tile grid and each body of content for association with each tile in the interactive tile grid for export to a web;
export the VORGAR to the web for accessibility by users over a web-based interface;
set up a user portal for accessibility by a plurality of users access the portal on the world wide web public network;
create a Visual Organization Architecture (VORGAR) database for recording user access and tracking users and user progress;
record user access to the user portal and to the VORGAR database;
track user progress in the learning modules;
allow users to log in and log out;
utilize a server having accessibility to the world wide web public network;
upload the VORGAR to the server;
connect the VORGAR to the VORGAR database; and
save a plurality of scores and a plurality of progress charts from users as users complete each learning module.

16. A system for developing and deploying a non-linear presentation platform, the system comprising:
at least one server accessible over the world wide web public network and configured to allow user and developer access and to host a database;
a secure database consisting of a plurality of database modules for the storage of data pertaining to the non-linear presentation platform;
an interactive grid of tiles formed within the non-linear presentation platform;
a user interface through which developers access the non-linear presentation platform across the network to design and develop a training course responsively as a client makes decisions on requirements and content;
a user interface through which users access the non-linear presentation platform across the network;
wherein the system is configured to:
gather a plurality of information data points that will be integrated into the non-linear presentation platform;
determine a plurality of tiles for an interactive visual presentation tile grid;
determine a plurality of dimensions for the interactive visual presentation tile grid;
create at least one artwork piece for each tile in the interactive visual presentation tile grid;
create a front image and a back image for each tile in the interactive visual presentation tile grid; and
form a Graphical User Interface (GUI) for each tile;
thereby to create a plurality of user-selectable learning module access points through the interactive visual presentation tile grid.

17. The system of claim 16, wherein the system is further configured to:
create a plurality of bodies of content, each body of content created for association with one of the tiles in the interactive tile grid through the plurality of user-selectable learning module access points through the interactive visual presentation tile grid;
thereby to create a plurality of user-selectable learning modules through the access points of the interactive visual presentation tile grid.

18. The system of claim 17, wherein the system is further configured to:
create a plurality of multi-choice questions for each learning module through the interactive visual presentation tile grid;
create a plurality of graphics, each graphic defined for each body of content for association with each tile in the interactive tile grid; and
couple each graphic to its respective body of content.

19. The system of claim 17, wherein the system is further configured to:
determine a plurality of video content packages, each determined for use with one of a plurality of videos, each video paired within each body of content created for association with one of the tiles in the interactive tile grid through the plurality of user-selectable learning module access points through the interactive visual presentation tile grid;
shoot a plurality of high quality videos based on the plurality of video content packages;
edit each video to create an edited video;
compress each edited video to form a compressed video; and
save each compressed video to form a saved compressed video;
thereby pair at least one video to each body of content for association with each tile in the interactive tile grid.

20. The system of claim 17, wherein the system is further configured to:
create a Visual Organization Architecture (VORGAR) from the interactive visual presentation tile grid and each body of content for association with each tile in the interactive tile grid for export to a web;
export the VORGAR to the web for accessibility by users over a web-based interface;
set up a user portal for accessibility by a plurality of users access the portal on the world wide web public network;
create a Visual Organization Architecture (VORGAR) database for recording user access and tracking users and user progress;
record user access to the user portal and to the VORGAR database;
track user progress in the learning modules;
allow users to log in and log out;
utilize a server having accessibility to the world wide web public network;
upload the VORGAR to the server;
connect the VORGAR to the VORGAR database; and
save a plurality of scores and a plurality of progress charts from users as users complete each learning module.
